(19) United States
(12) Patent Application Publication
(10) Pub. No.: US 2009/0107061 A1
(43) Pub. Date: Apr. 30, 2009

(54) REINFORCEMENT OF SLIDING GLASS DOORS AND WINDOWS

(76) Inventor: William Guthrie, Wellington, FL (US)

Correspondence Address: MALIN HALEY AND DIMAGGIO, PA, 1936 S ANDREWS AVENUE, FORT LAUDERDALE, FL, 33316, US

(21) Appl. No.: 12/261,332

(22) Filed: Oct. 30, 2008

Related U.S. Application Data
(60) Provisional application No. 61/000,985, filed on Oct. 30, 2007.

(51) Int. Cl. E06B 5/10; E06B 3/46; E06B 1/04

(52) U.S. Cl. 52/207; 52/741.3

(57) ABSTRACT

A reinforcement system for installation on sliding glass doors and windows to reinforce those structures against storm force winds, such as those experienced during a hurricane. An elongate rigid member is affixed to interior portion of the sliding glass doorframe by threaded fasteners to provide increased structural integrity. The elongate rigid member comprises a generally hollow member formed of extruded aluminum having a length that is generally equal to the height of the interior side frame member of the sliding glass door. The elongate rigid member is preferably installed on the side frame member disposed generally at or near the center of the opening in a two-door installation. Additional members may be used for installations having more than two doors. Once installed, the elongate rigid member increases the structural integrity of the sliding glass door structure by increasing the ability of the door to withstand being blown inward (or outward) by storm force winds.

### CROSS REFERENCE TO RELATED APPLICATIONS

This application claims the benefit of provisional U.S. Patent Application Ser. No. 61/000,985, filed on Oct. 30, 2007.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all rights whatsoever.

### BACKGROUND OF THE INVENTION

1. Field of the Invention

The present invention relates to a sliding doors and windows used in homes and buildings, and particularly to reinforcement of sliding doors and windows to provide support for enhancing the strength and the ability of the sliding doors and windows to withstand storm force winds. More particularly, the present invention relates to a reinforcement system for sliding glass doors and windows to prevent the doors from bowing and failing in the face of storm force winds.

2. Description of Related Art

Over the past 20 years the United States has experienced numerous weather-related disasters each of which caused in excess of $1 billion in damages. In 2004, the State of Florida was subjected to direct hits from multiple hurricanes the combined effect of which resulted in damages of approximately 20 billion dollars.

In addition, population growth along the coastline of the United States has resulted in an increased risk to life and property from hurricane related damage. There are approximately 40 million permanent residents along the hurricane-prone coastline of the United States, with areas such as Texas, Florida, and the Carolinas, where hurricanes frequently strike, experiencing rapid population growth. Furthermore, many coastal areas experience substantial but temporary population increases from holiday, weekend, and vacation visitors during hurricane season.

Homes, buildings, and other structures, suffer substantial damage when storm generated winds carrying windborne debris penetrate the structures through window and door openings. Hurricane shutters have long been used as barriers to protect window and door openings from the effects of storm generated winds. Equipping homes and other buildings with hurricane protection in the form of storm shutters is one of the most prudent actions one can take to protect life and property. It has been found that sliding glass door openings are particularly vulnerable to storm force winds.

Accordingly, the background art reveals a number of storm shutters and other devices designed for permanent or removable installation on homes and buildings. U.S. Pat. No. 6,415,565, issued to Sosa, discloses a storm rail comprising a support brace for structurally linking a sliding door to a surrounding structure. The rail is fastened to a portion of the sliding door in spaced relation to the surrounding structure so that the first end is positioned adjacent to a top edge of the sliding door and the second end is positioned adjacent to a bottom edge of the sliding door. U.S. Pat. No. 5,113,629, issued to Carrick, discloses a device for preventing the removal of the glass pane of the non-slideable door or panel of a standard sliding glass assembly using an elongated bent cylindrical member is adapted to be mounted on the non-slideable door frame on both the top and bottom of the exposed inner, vertical frame member in a non-removable fashion. Finally, U.S. Pat. No. 4,891,921, issued to Governale, discloses a sliding door assembly having a frame including a head jamb, a bottom sill, two vertical side jambs and a third center jamb for strength and rigidity of the overall frame.

The systems shown in the prior art are each burdened by shortcomings and disadvantages. For example, the structures disclosed by Sosa and Carrick only engage the doors near the top and bottom and fail to provide any reinforcement in the center portion wherein the highest moment forces are experienced. The Governale reference requires a complex aid specialized assembly that includes the addition of a third center jamb and is not suitable for use in retrofit applications with existing sliding glass door systems.

Accordingly, there exists a need for an improved system for reinforcing sliding glass doors and windows against storm force winds. There further exists a need for such a system that is easy to install and does not significantly detract from the original appearance of the sliding glass door structure.

### BRIEF SUMMARY OF THE INVENTION

The present invention overcomes the disadvantages and limitations in the art by providing a system for installation on sliding glass doors to provide reinforcement against storm force winds, such as those experienced during a hurricane. A reinforcement system in accordance with the present invention comprises affixing an elongate rigid member to an interior portion of the sliding glass doorframe to provide increased structural integrity. In a preferred embodiment, the elongate rigid member comprises a generally hollow member formed of extruded aluminum having a length that is generally equal to the length of the interior side frame member of the sliding glass door. The elongate rigid member is preferably installed on the side frame member disposed generally in the center of the opening in a two-door installation, and additional members may be used for installations having more than two doors. The elongate rigid member is preferably secured to the inside or outside portion of the frame of the sliding glass door by a mating engagement of an integral projecting attachment clip structure with the door frame and/or by the use of threaded fasteners. Once installed, the elongate rigid member increases the structural integrity of the sliding glass door structure by increasing the ability of the door (or window) to withstand being blown inward (or outward) by storm force winds. The structure of the present invention is equally applicable for use with windows.

Accordingly, it is an object of the present invention to provide a system for reinforcing sliding glass doors and windows.

A further object of the present invention is to provide such a system that is simple and easy to install without modification of the frame surrounding the opening.

Still another object of the present invention is to provide such a system that functions to support the entire length of the sliding glass doorframe.

In accordance with these and other objects, which will become apparent hereinafter, the instant invention will now be described with particular reference to the accompanying drawings.

### BRIEF DESCRIPTION OF THE SEVERAL VIEWS OF THE DRAWINGS

FIG. 1 is a top perspective view of a structural reinforcing member for windows and doors in accordance with the present invention;

FIG. 2 is an end view thereof;

FIG. 3 is a sectional view depicting a two section sliding glass door with reinforcing members installed;

FIG. 4 is a top perspective view of an alternate embodiment structural reinforcing member for windows and doors in accordance with the present invention;

FIG. 5 is an end view thereof;

FIGS. 6 and 7 are perspective sectional views depicting a two section sliding glass door with alternate embodiment reinforcing members installed;

FIG. 8 is a sectional view depicting a two section sliding glass door with reinforcing members installed; and

FIG. 9 is a partial perspective view depicting yet another alternate embodiment structural reinforcing member for windows and doors in accordance with the present invention.

### DETAILED DESCRIPTION OF THE INVENTION

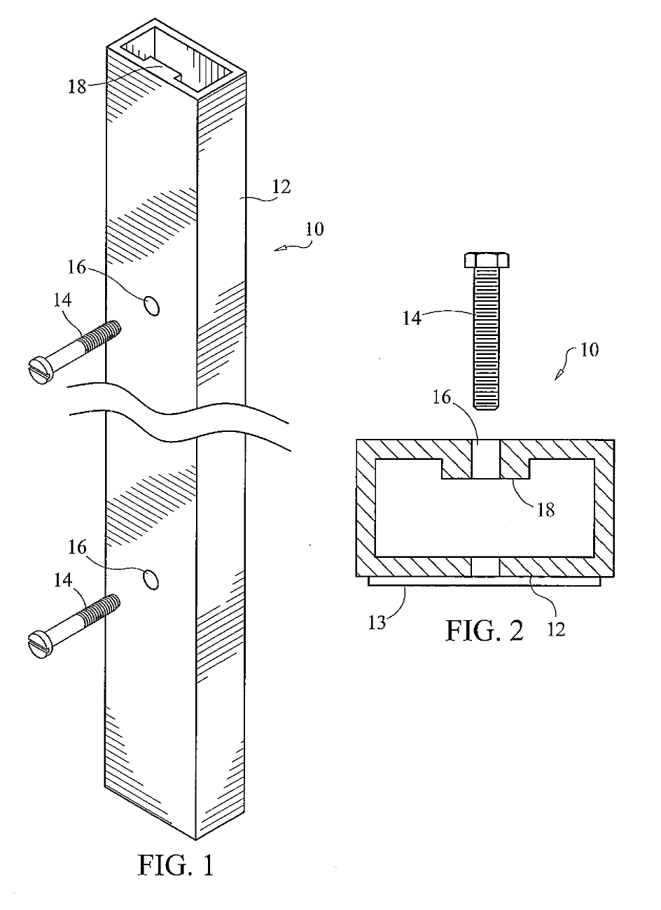

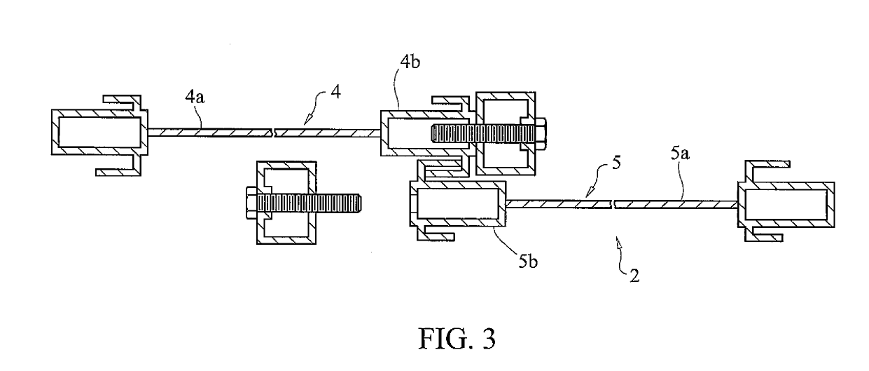

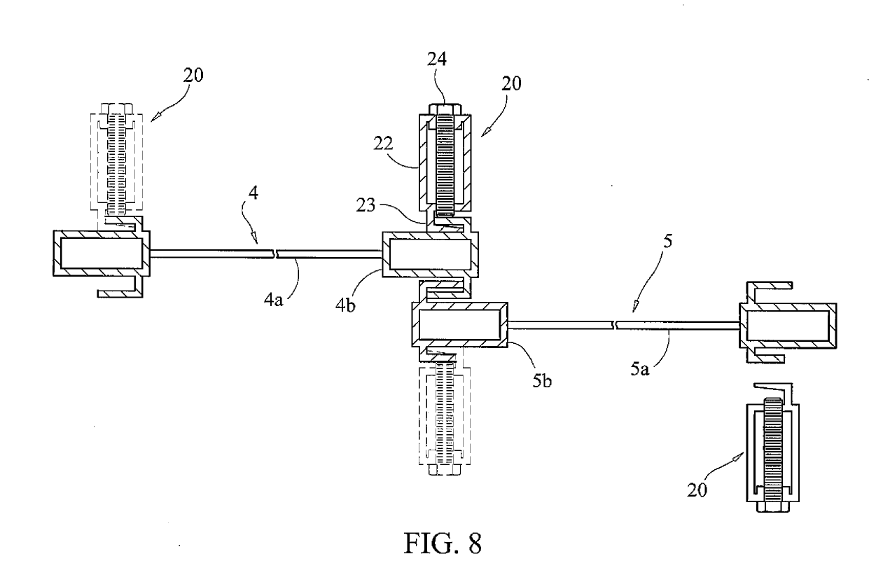

With reference now to the drawings, FIGS. 1-9 illustrate structural reinforcement of sliding glass doors in accordance with the present invention. Turning first to FIGS. 1-3 there is depicted a preferred structural reinforcing system, generally referenced as 10, that provides a simple and easy to install system that provides reinforcement against storm force winds, such as those experienced during a hurricane. The present invention is specifically intended for use with sliding glass door and window assemblies, generally referenced as 2 in FIG. 3, of the type commonly used for providing ingress and egress in residential and commercial buildings. These sliding glass door assemblies may include a fixed section 4 and a movable section 5 adapted for sliding between open and closed positions. Each section, fixed and movable, typically includes a pane of glass (4a and 5a) secured within a peripheral frame (4b and 5b). FIG. 3 shows a two-section assembly having a fixed section 4 and movable section 5.

Turning now to FIG. 1, a structural reinforcement system 10 according to the present invention comprises an elongate rigid member 12 preferably affixed to an interior portion of the sliding glass door frame to provide increased structural integrity. In a preferred embodiment, elongate rigid member 12 comprises a generally hollow member formed of extruded aluminum having a length that is approximately generally equal to the height of the interior side frame member 4b or 5b of movable sliding glass door 6. In a preferred embodiment, elongate rigid member 12 defines a generally hollow and generally rectangular cross-section. Elongate rigid member 12 is preferably affixed to the frame members 4b or 5b of sliding glass doors 4 and/or 5 using threaded fasteners 14 received in thru bores 16 defined as shown in FIG. 1. Any suitable number of thru bores and fasteners, as well as spacing thereof may be used. Elongate member 12 may further include a thickened wall portion 18 to provide sufficient and reinforced threaded engagement between fasteners 14 and member 12. As best seen in FIG. 3, in order to maximize resistance to bending and moment forces elongate rigid member 12 is affixed with the long dimension of the rectangular cross-section is disposed perpendicular to the opening/glass thereby maximizing resistance to deflection, bending, and bowing.

The present inventor has found that storm force winds are capable of overstressing the fasteners thereby leading to fastener failure when a reinforcing member is installed on a large sliding glass door assembly. Accordingly, the present invention further includes the use of double-sided tape to provide an adhesive connection between the reinforcing member and door/window frame, in addition to the mechanical connection provided by the fasteners. As seen in FIG. 2, at least one strip of double-sided tape, referenced as 13, may be affixed to member 12 so as to engage the door/window frame and provide an adhesive bond. The additional adhesive connection has been found to prevent fastener failure by improving the connection between the reinforcing member and the door or window frame. Once installed, the elongate rigid member increases the structural integrity of the sliding glass door structure by increasing the ability of the door to withstand being blown inward (or outward) by storm force winds. Elongate rigid member 12 is preferably installed on the interior side of the sliding glass door assembly however, it may also be installed on the exterior side without departing from the scope of the present invention.

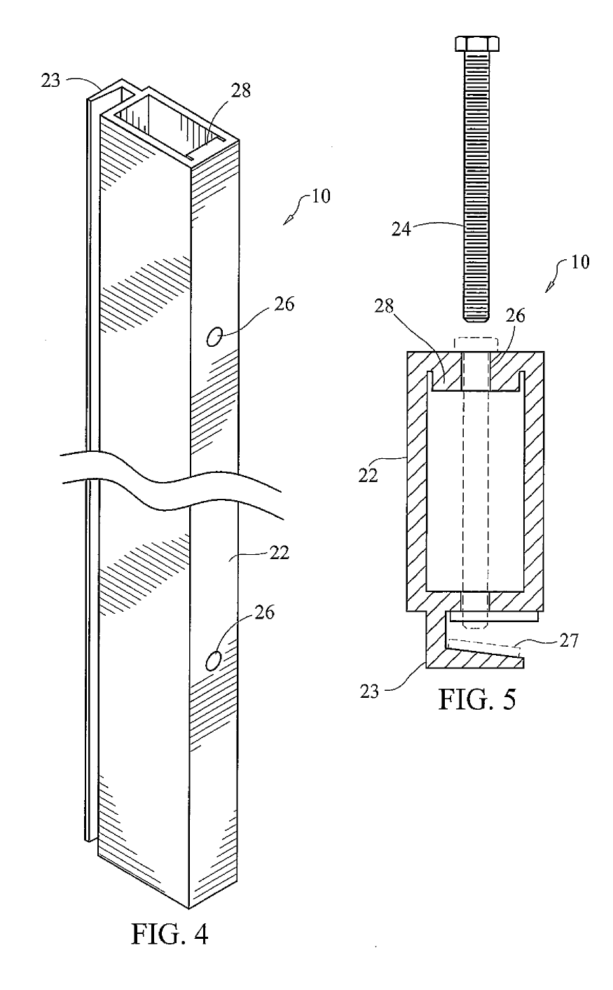

FIGS. 4-8 depict an alternate embodiment structural reinforcing system 20 in accordance with the present invention adapted for use with sliding glass door and window frames that have a recessed notch running substantially the entire length of the frame. Structural reinforcement system 20 according to the present invention comprises an elongate rigid member 22 preferably affixed to an interior portion of the sliding glass door frame to provide increased structural integrity. Elongate rigid member 22 comprises a generally hollow member formed of extruded aluminum having a length that is approximately generally equal to the height of the interior side frame member. In a preferred embodiment, elongate rigid member 22 defines a generally hollow and rectangular cross-section. Elongate rigid member 12 further includes a first side having a generally L-shaped attachment clip 23 projecting therefrom and running substantially from one end thereof to the other of rigid member 22. A significant aspect of the present invention involves providing an attachment clip 23 sized for mating engagement with the existing recessed notch defined on certain sliding glass door frames. More particularly, a number of existing sliding glass door and window assemblies have existing metallic frames, typically aluminum, that define an existing notch. Clip 23 preferably defines a tapered notch between the inner surface of the clip and the outer surface of rigid member 22 as best seen in FIG. 5. The tapered notch functions to achieve press-fit type engaged attachment of member 22 to a frame member.

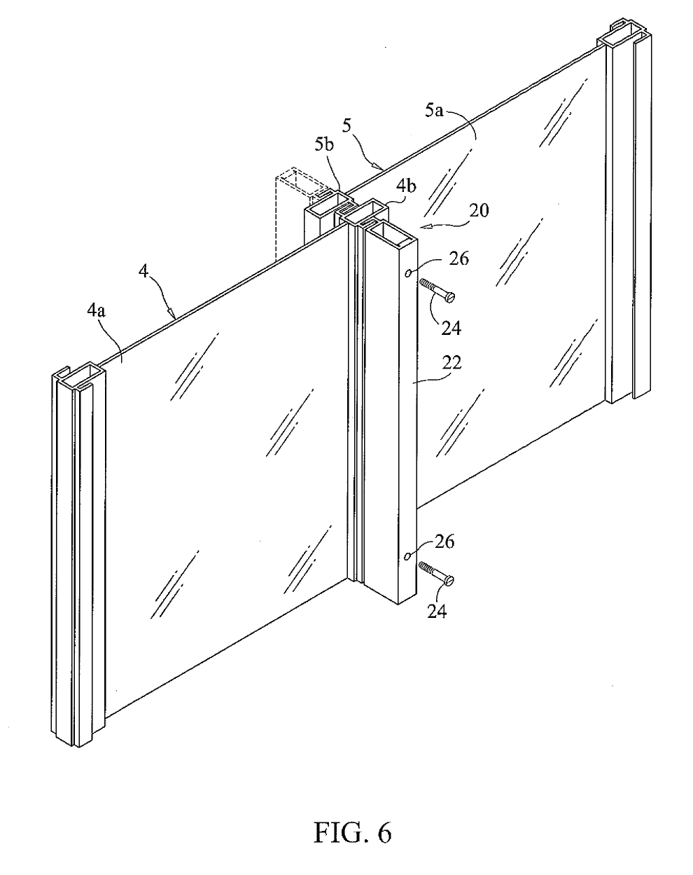

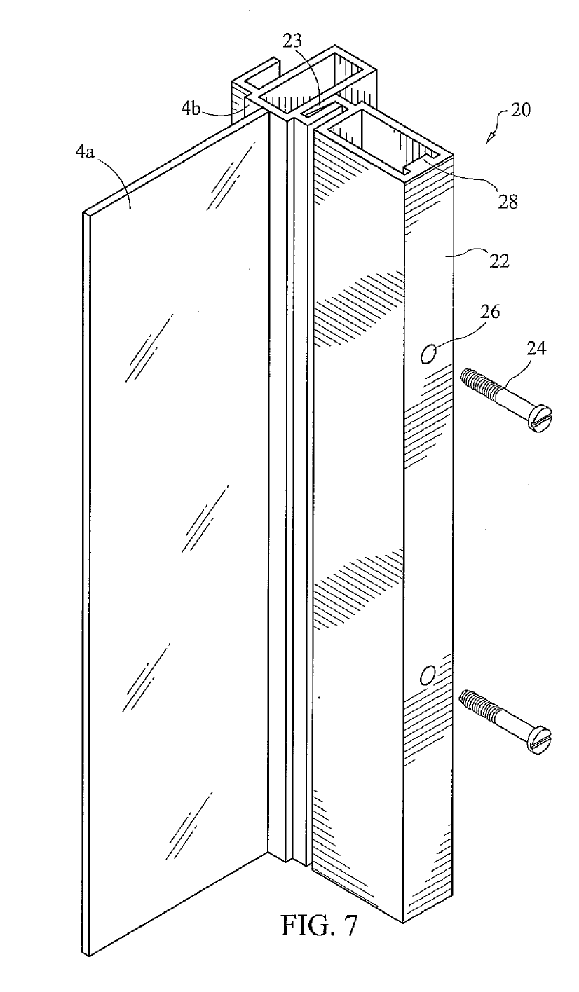

Elongate rigid member 22 is preferably affixed to the frame members 4b or 5b of sliding glass doors 4 and/or 5 using threaded fasteners 24 received in thru bores 26 defined in member 22 as shown in FIGS. 6 and 7. Any suitable number of thru bores and fasteners, as well as spacing thereof, may be used. Elongate member 22 may further include a thickened wall portion 28 to provide sufficient and reinforced threaded engagement between fasteners 24 and member 22. In this embodiment, fasteners 24 may be tightened such that the tip end thereof engages the frame structure received within the tapered notch defined by the inner surface of clip 23 and the outer surface of member 22. Upon engaging the frame, further tightening of fastener 24 functions to provide secure affixation by sandwiching the frame between clip 23 and fastener 24 and forming a press fit connection. As best seen in FIGS. 6-8, in order to maximize resistance to bending and moment forces elongate rigid member 22 is affixed with the long dimension of the rectangular cross-section is disposed perpendicular to the opening/glass thereby maximizing resistance to deflection, bending, and bowing. As illustrated in FIG. 5, member 22 may farther include at least one strip of double sided tape, referenced as 27, to strengthen the connection by providing an adhesive bond between member 22 and the door/window frame. Once installed, the elongate rigid member increases the structural integrity of the sliding glass door structure by increasing the ability of the door to withstand being blown inward (or outward) by storm force winds.

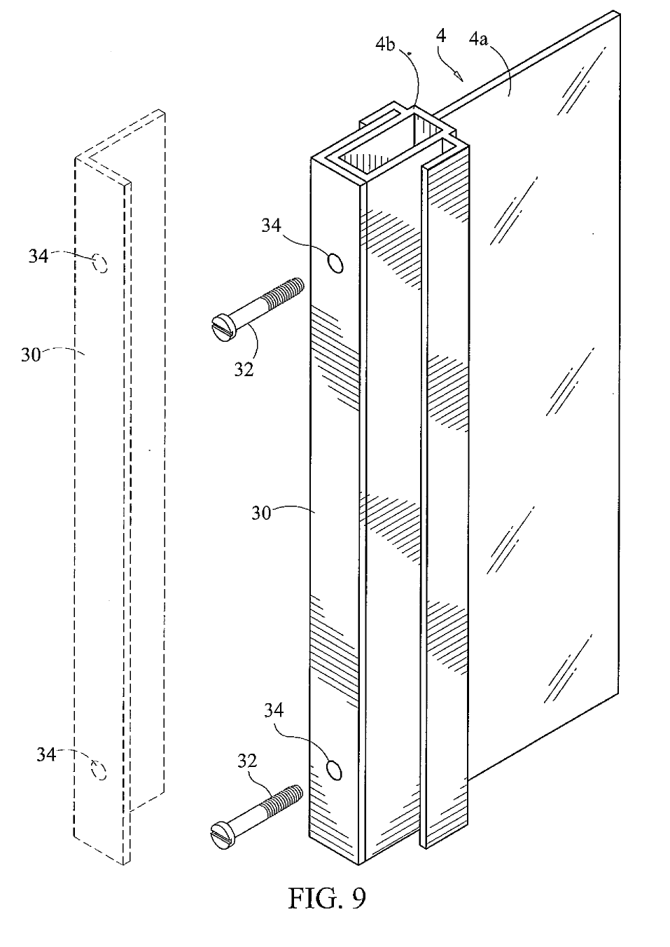

Finally, FIG. 9 depicts an alternate embodiment L-shaped elongate rigid member, referenced as 30. L-shaped rigid member 30 is depicted installed in a first configuration on an extruded frame 4b. Each L-shaped rigid member may be secured by suitable fasteners 32 received insertedly received within thru bores 32. Member 30 may her include a projecting leg (not shown) extending perpendicular to glass 4a to provide additional structural rigidity thereby rendering the cross-sectional shape as generally T-shaped.

The instant invention has been shown and described herein in what is considered to be the most practical and preferred embodiment. It is recognized, however, that departures may be made therefrom within the scope of the invention and that obvious modifications will occur to a person skilled in the art.

What I claim is:

1. A method of reinforcing a sliding glass door assembly installed in a building opening wherein the sliding glass door assembly includes a perimeter frame and a generally central frame member traversing the opening, said method comprising the steps of:
providing an elongate reinforcing member;
affixing said reinforcing member to the generally central frame member traversing the opening.

2. A method of reinforcing a sliding glass door assembly according to claim 1, wherein said reinforcing member comprises an elongate generally hollow member having a generally rectangular cross-section, said cross-section formed by a first pair of opposing sides forming a cross-sectional length and a second pair of opposing sides forming a cross-sectional width, wherein the dimension of said length exceeds the dimension of said width, and wherein said first pair of opposing sides are disposed generally perpendicular to said opening when affixed.

3. A method of reinforcing a sliding glass door assembly according to claim 2, further including affixing said reinforcing member using double-sided tape.

4. A method of reinforcing a sliding glass door assembly according to claim 2, wherein at least one of said second pair of opposing sides includes an outwardly projecting clip defining a notch for receiving a portion of the generally central frame member traversing the opening sandwiched between said clip and said rigid member side.

5. A method of reinforcing a sliding glass door assembly according to claim 3, wherein said second pair of sides define a plurality of spaced apertures with threaded fasteners received within said apertures, each of said fasteners having a head and a tip and configurable such that said tip engages the portion of the generally central frame member traversing the opening received within said notch and deforms the portion of the generally central frame member traversing the opening into press fit engagement with said clip.

6. An apparatus for reinforcing a sliding glass door assembly installed in a building opening wherein the sliding glass door assembly includes a perimeter frame and a generally central frame member traversing the opening, said apparatus comprising:
an elongate reinforcing member attachable to the generally central frame member traversing the opening;
said reinforcing member forming an elongate generally hollow member having a generally rectangular cross-section, said cross-section formed by a first pair of opposing sides forming a cross-sectional length and a second pair of opposing sides forming a cross-sectional width, wherein the dimension of said length exceeds the dimension of said width, and wherein said first pair of opposing sides are disposed generally perpendicular to said opening when attached; and
means for attaching said elongate reinforcing member to the generally central frame member traversing the opening.

7. An apparatus for reinforcing a sliding glass door assembly according to claim 6, wherein said means for attaching includes a mechanical fastener.

8. An apparatus for reinforcing a sliding glass door assembly according to claim 6, wherein said means for attaching includes an adhesive bond.

9. An apparatus for reinforcing a sliding glass door assembly according to claim 6, wherein said means for attaching includes at least one of said second pair of opposing sides having an outwardly projecting clip defining a notch for receiving a portion of the generally central frame member traversing the opening sandwiched between said clip and said rigid member side.

10. An apparatus for reinforcing a sliding glass door assembly according to claim 6, wherein said second pair of sides define a plurality of spaced apertures with threaded fasteners received within said apertures, each of said fasteners having a head and a tip and configurable such that said tip engages the portion of the generally central frame member traversing the opening received within said notch and deforms the portion of the generally central frame member traversing the opening into press fit engagement with said clip.
